(19) United States
(12) Patent Application Publication
(10) Pub. No.: US 2024/0353651 A1
(43) Pub. Date: Oct. 24, 2024

(54) Scan Engine Ranging Failure Handling

(71) Applicant: ZEBRA TECHNOLOGIES CORPORATION, Lincolnshire, IL (US)

(72) Inventors: Vladimir Gurevich, Great Neck, NY (US); Andrew Cornell, East Northport, NY (US)

(21) Appl. No.: 18/137,258

(22) Filed: Apr. 20, 2023

(51) Int. Cl. H04N 23/67; G06K 7/10; G06K 7/14; H04N 23/45; H04N 23/56

(52) U.S. Cl. CPC H04N 23/671; G06K 7/10831; G06K 7/1439; H04N 23/45; H04N 23/56; G06K 2007/10524

(57) ABSTRACT

The disclosure is an imaging system having a controller configured to activate and deactivate a light source, an imaging assembly configured to capture imaging data of an environment appearing within a field of view of the imaging assembly, and a focus module configured to set a focus characteristic of the imaging assembly. The focus module may set the focus characteristic based on the image processor executing the focusing sequence in response to the ranging failure.

### BACKGROUND

Imaging systems are used in many applications, and thus require an adjustable focus assembly to image indicia, or targets, at various distances. In some situations, the imaging system may not effectively acquire ranging data. Without the requisite ranging data, the imaging system can experience a ranging failure, leading to the inability to set a defined focal range of the adjustable focus assembly. Therefore, there is a need for systems, devices, and methods, which will reactively set the appropriate focus parameter in response to the imaging system experiencing a ranging failure.

### SUMMARY

In an embodiment, the present invention is an imaging system for use in a variable focus indicia reader, comprising a light source configured to direct an aiming light pattern to a target, the light source directed along a first axis and a controller configured to activate and deactivate the light source. The imaging system further includes an imaging assembly configured to capture imaging data of an environment appearing within a field of view of the imaging assembly, wherein imaging data comprises a first image of the target along a second axis and a second image of the target along the second axis, wherein the light source is deactivated during capture of the first image and the light source is activated during capture of the second image; an image processor configured to execute a focusing sequence in response to a ranging failure, wherein the focusing sequence comprises a focus ramp profile determined from a user selectable profile; and a focus module configured to set a focus characteristic of the imaging assembly based on the image processor executing the focusing sequence in response to the ranging failure.

In another embodiment, the present invention is a method of determining a distance to a target to be read by an imaging system, comprising: activating a light source configured to direct an aiming light pattern to a target, the light source directed along a first axis; capturing a first image of the target along a second axis; deactivating the light source; capturing a second image of the target along the second axis; and setting a focus characteristic of an imaging assembly based on an image processor executing a focusing sequence in response to a ranging failure, wherein the focusing sequence comprises a focus ramp profile determined from a user selectable profile.

In yet another embodiment, the present invention is a non-transitory computer readable storage medium storing one or more computer programs adapted to cause a processor based system to execute steps comprising: activating a light source configured to direct an aiming light pattern to a target, the light source directed along a first axis; capturing a first image of the target along a second axis; deactivating the light source; capturing a second image of the target along the second axis; and setting a focus characteristic of an imaging assembly based on an image processor executing a focusing sequence in response to a ranging failure, wherein the focusing sequence comprises a focus ramp profile determined from a user selectable profile.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a side view of an example imaging system of the present disclosure.

FIG. 2 is a diagram of an example imaging system of the present disclosure.

FIG. 3 is a view of an example aiming light pattern of the imaging system of the present disclosure.

FIG. 4 is a view of an example aiming light pattern of the imaging system when the imaging system determines the position of the aiming light pattern of the present disclosure.

FIG. 5 is an example flow chart illustrating blocks for determining the target distance in accordance with the present disclosure.

FIGS. 6A-C are example embodiments of various focusing sequences in accordance with the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

An imaging system may be used in a variable focus indicia reader, which can be implemented as a platform indicia reader or a scan engine in a handheld imaging system. In an example, a handheld imaging system is used to scan a two-dimensional bar code. Generally, the scan engine is located in the housing of the handheld imaging system, which further includes a handle held by a user.

The imaging system includes an imaging assembly having an imager with an imaging array of photocells or light sensors, which correspond to image elements or pixels in an imaging field of view. The imaging system may further include an imaging lens assembly for capturing return light scattered and reflected from the target being imaged and for projecting the return light onto the array to initiate capture of an image of the target. The imager may include a one-dimensional or two-dimensional charge coupled device (“CCD”) or a complementary metal oxide semiconductor (“CMOS”) device and associated circuits for producing and processing electronic signals corresponding to an array of pixel data over the imaging field of view.

To increase the amount of the return light captured by the array, for example, in a dimly lit environment, the imaging system may also include an illuminating light assembly for illuminating the target, preferably with a variable level of illumination light for reflection and scattering from the target. The illuminating light assembly may include an illumination light source and an illuminating lens. The imaging system may also include an aiming assembly for projecting an aiming light pattern onto a target with an aiming light source and an aiming lens.

In some applications, imaging systems must work at a range of distances, and thus, include a focus module. In an example, the imaging system determines the distance, or range, to the target by determining the position of an aiming light pattern. Once the distance is determined, the imaging system may adjust the focus module accordingly. However, in some situations, the imaging system is not able to determine the distance, which may occur for a variety of reasons. Without the distance to the target, the imaging system would be unable to adjust the focus module.

In response, the imaging system may execute a focusing sequence to manually determine the distance to the target. For example, the imaging system may start with far distances and progressively reduce the distance overtime until the distance is determined. However, this process may rely on capturing and processing many images over many successive frames over a relatively long time period of time to determine the best focus distance. The specific order of capturing many images at specific times and distances corresponds to the focus ramp profile of the focusing sequence. This increase of time caused by the focus sequence is undesirable in many applications. Accordingly, there is a need for imaging systems with improved systems and methods for target focusing.

The imaging system of the present disclosure includes an imaging system having a controller that can activate and deactivate a light source. In response to activation by the controller, the light source is configured to direct an aiming light pattern along an aiming axis, or first axis, to a target. The imaging system may further include an assembly, or imaging assembly, for capturing imaging data of an environment appearing within a field of view of the imaging assembly. In an example, the imaging data includes a first image of the target along an imaging axis, or second axis, and a second image of the target along the imaging axis. Before capturing the first image, the controller activates the light source to direct the aiming light pattern along the aiming axis onto the target. Thus, the first image contains the aiming light pattern with the light source activated. Before capturing the second image, the controller deactivates the light source.

The first image and the second image are captured in a frame over a field of view having the imaging axis offset from the aiming axis. And once captured, the first image and the second image are used to obtain first image data and second image data, which correspond to average brightness values for determining the position of the aiming light pattern. Namely, the image processor uses a comparison between the first image data and the second image data over a common fractional region of both frames to determine the position of the aiming light pattern in the first image. The position of the aiming light pattern in the first image is then used to determine the distance to the target.

However, a ranging failure may occur, preventing the imaging system from determining the distance to the target. In high ambient lighting conditions, the image processor may be unable to determine the position of the aiming light pattern. Further, the aiming light pattern used by the imaging system to determine distance could be improperly placed on a reflective or black surface. While only a few examples are listed, there are many reasons for a ranging failure to occur. Although an imaging system may execute an automatic focusing sequence to manually determine the distance of the target, the focusing sequence may cause undesirable delays.

Thus, the imaging system of the present disclosure may instead set a focus characteristic of the imaging assembly based on the image processor executing a focusing sequence that comprises a focus ramp profile determined from a user selectable profile. In an illustrative example, an operator activates the imaging system and sets the user selectable profile as a far range priority mode. In other examples, the operator can set the user selectable profile as a near range priority mode or a mixed range priority mode. When a ranging failure occurs, the focus ramp profile of the focusing sequence executed by the imaging assembly is determined from the user selectable profile.

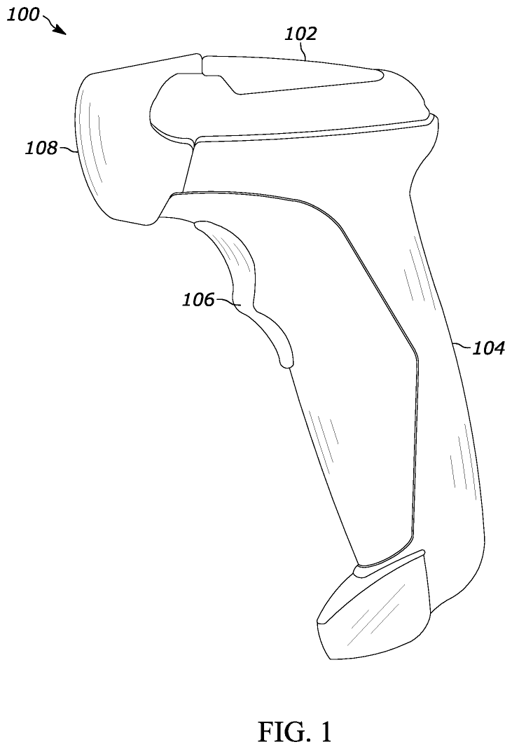

FIG. 1 is a side view of the imaging system of the present disclosure. The imaging system 100 includes an upper portion 102 having a window 108 and a lower portion 104 having a trigger 106. The lower portion 104 may be titled away from the upper portion 102 at a desired angle of inclination at, for example, fifteen degrees. In an illustrative example, a user grips the lower portion 104 of the imaging system 100 as a handle. Then, a user may actuate the trigger 106 on the lower portion 104 by manually depressing the trigger 106. Once actuated, the trigger 106 may initiate the imaging system 100 to image a target, which can be, for example, a bar code. Imaging systems of varying configurations could also be employed for handheld or hands free operations.

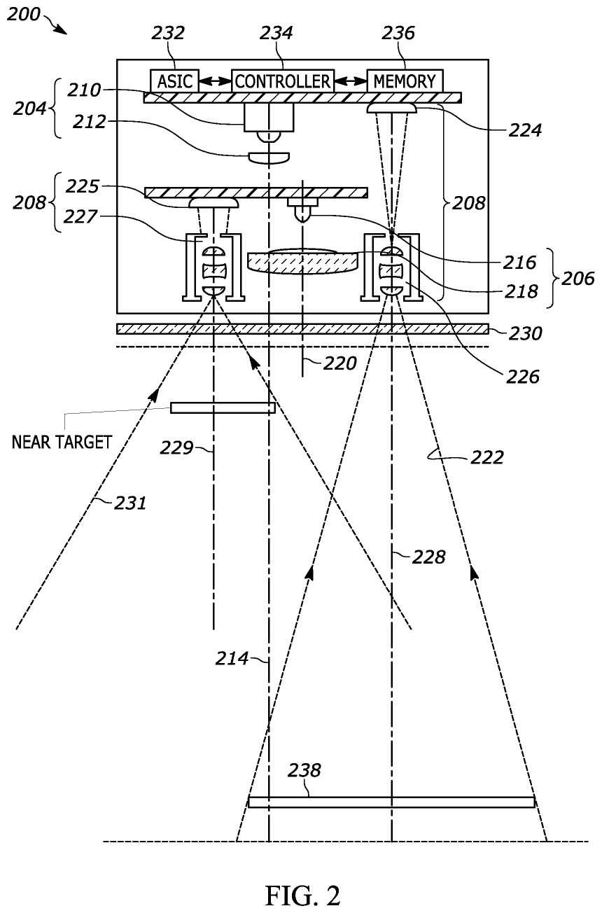

FIG. 2 is a diagram of an imaging system of the imaging system of the present disclosure. In reference to FIG. 1, the imaging system 200 is mounted behind the window 108 in the top portion 102 of the imaging system 100. The imaging system 200 is configured to read targets by capturing images through the window 230 over a range of working distances. As used throughout the detailed description, a working distance is defined by the distance between the window 230 and the target. The working distances of the imaging system 200 may include near distances and far distances. Near distances may include a few inches while far distances may include several feet.

The imaging system 200 includes an aiming assembly 204, an illumination assembly 206, and an imaging assembly 208. The aiming assembly 204 includes a light source 210 and an aiming lens 212. The aiming assembly 204 and the aiming lens 212 are mounted on an aiming axis 214. In an example embodiment, the aiming lens 212 is a diffractive or a refractive optical element. The aiming lens 212 projects the light source 210 onto a target 238 as an aiming light pattern along the aiming axis 214. The aiming light pattern can be a laser or visible light.

The illumination assembly 206 includes an illumination light source 216 and an illumination lens 218. The illumination light source 216 and the illumination lens 218 are mounted on an optical axis 220. In an example, the illumination light source 216 is a light emitting diode (“LED”). The illumination assembly 206 is configured to emit illumination light at a variable illumination level from the scan engine.

The imaging assembly 208 captures return light over a field of view and includes a far imager 224, a near imager 225, a far focus module 226, and a near focusing module 227. The far imager 224 and the far focus module 226 are mounted on a first imaging axis 228 having a narrow imaging FOV 222. The near imager 225 and the near focus module 227 are mounted on a second imaging axis 229 having a wide imaging FOV 231. The far focus module 226 and the near focus module 227 are configured to focus the imaging assembly 208 on the target by setting a focusing characteristic. Example focus modules include motors, movable lenses, and liquid lenses. In some examples, the far focus module 226 and the near focus module 227 are controlled by the imaging system 200.

The far imager 224 and the near imager 225 are solid-state devices. In an example, the far imager 224 and the near imager 225 are each a CD or CMOS imager having a one-dimensional array of addressable image sensors or pixels arranged in a single, linear row. The far imager 224 and the near imager 225 may also include a CD or a CMOS imager having a two-dimensional array of addressable image sensors or pixels arranged in mutually orthogonal rows and columns, operative for detecting return light captured by the imaging assembly 208.

The imaging system 200 may further include an image processor 232 and a controller 234 connected to a memory 236. The controller 234 is operatively connected to the far imager 224, the near imager 225, the illumination light source 216 of the illumination assembly 206, and the light source 210 of the aiming assembly 204, such that the controller 234 can control the operation of the far imager 224, the near imager 225, the illumination light source 216 of the illumination assembly 206, and the light source 210 of the aiming assembly 204. In an example embodiment, the controller 234 also processes the return light from the target 238 and decodes the captured target images. The image processor 232 is operatively connected between the far imager 224, the near imager 225, and the controller 234 for pre-processing the images captured.

Further, the image processor 232 is used to analyze the images captured in order to determine the position of the aiming light pattern. To minimize cost, the image processor 232 is preferably incorporated in a low power, low processing device, preferably without a frame buffer to store images. As a result, the image processor 232 is not tasked with analyzing each entire captured image, but instead, only analyzes a portion of each captured image, especially the portion of the image in which the aiming light pattern is expected to appear along a trajectory. The image processor 232 may be an application specific integrated circuit (“ASIC”) or a field-programmable gate array (“FPGA”). The image processor 232 may also be integrated with the controller 234.

The aiming axis 214 is offset from optical axis 220, resulting in a parallax between an aiming light pattern on the aiming axis 214 and the optical axis 220 for providing target distance information. Namely, the parallax between the aiming axis 214 and the optical axis 220 provides range information from the pixel position of the aiming light pattern on one of the imaging sensor arrays.

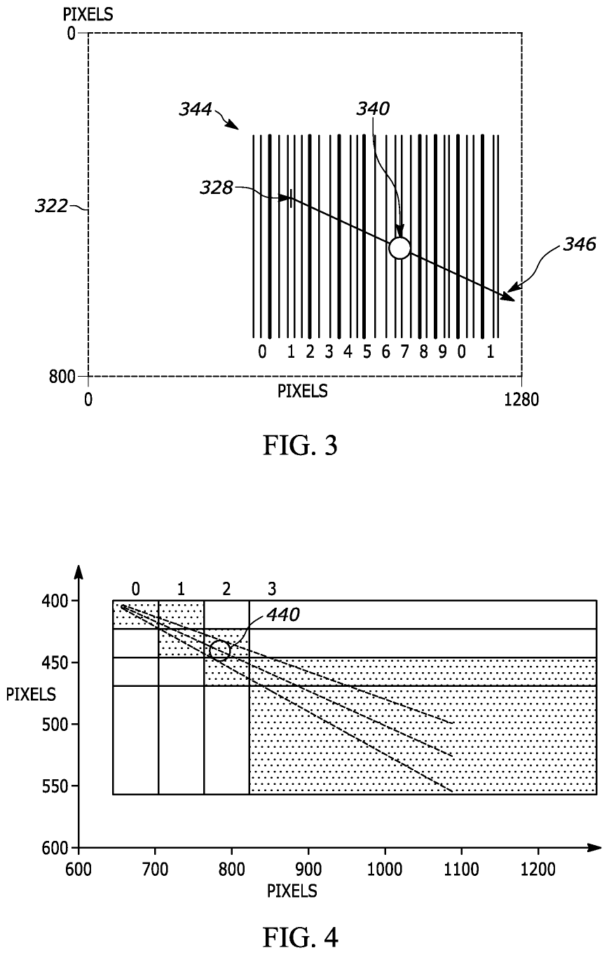

FIG. 3 is a view of an aiming light pattern of the imaging system of the present disclosure. FIG. 3 illustrates a target configured as a symbol 344 in a field of view 322. By determining the position of the aiming light pattern 340 relative to the imaging axis 328, the working distance of the symbol 344 can be determined. In an example embodiment, the spacing between the aiming light pattern 340 and the imaging axis 328 is proportional to the reciprocal of the working distance. Preferably, the position of the aiming light pattern 340 along a trajectory 346 is calibrated in advance during imaging system manufacture. In an example, symbol 344 is a two-dimensional resolution of 800 rows of pixels in height by 1280 columns of pixels in width. However, to leverage the relationship between the aiming light pattern 340 and the imaging axis 328, the imaging system must first determine the position of the aiming light pattern 338.

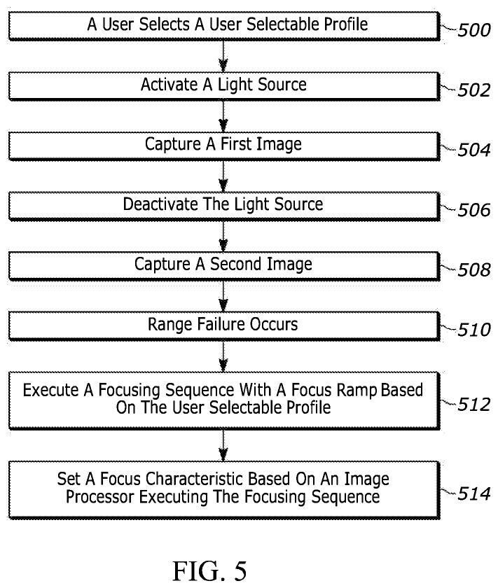

FIG. 4 is a view of an aiming light pattern of the imaging system when the imaging system determines the course position of the aiming light pattern of the present disclosure. As previously introduced, the image processor 232 of FIG. 2 is used to analyze the captured images and determine the position of the aiming light pattern 440. The image processor 232 uses average brightness values from an image of the target to determine the position of the aiming light pattern 440. However, as shown in FIG. 4, the image processor 232 does not analyze portions of the image where the aiming light pattern 440 is not expected to be positioned. Thus, in FIG. 4, the image processor 232 does not analyze: (1) the pixels in row 0 to about row 400; (2) the pixels in about row 560 to row 800; or (3) the pixels in column 0 to about column 640. The image processor 232 may conserve processing power and time by only analyzing pixels where the aiming light pattern 440 will be present. The fractional region or remaining area contains only about 160 rows of the original 800 rows of the full first image, and can thus be captured and analyzed much faster than the full first image.

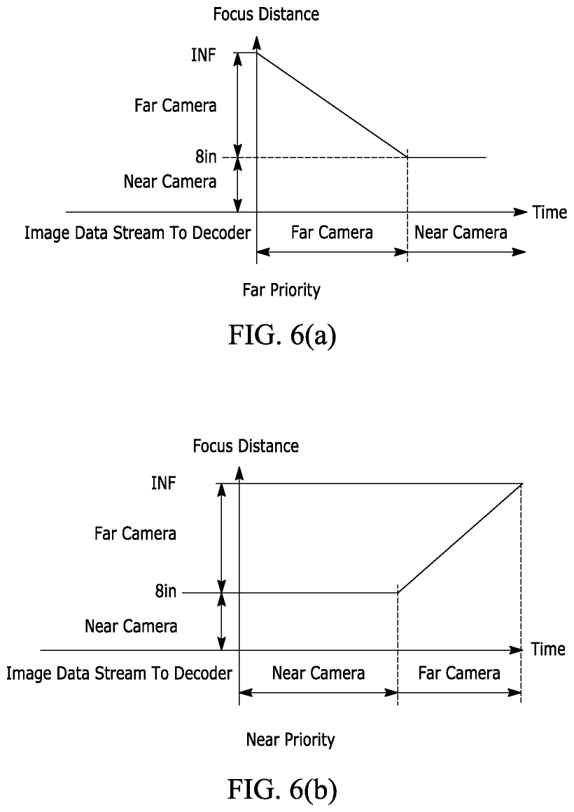

FIG. 5 is a flow chart illustrating an example process 501 of determining a distance to a target to be read by an imaging system in accordance with the present disclosure. As introduced above, a user may select a user selectable profile (block 500). For example, the user may select a far range priority mode, a near range priority mode, or a mixed range priority mode. Next, a user may actuate the imaging system by depressing the trigger, activating a light source configured to direct an aiming light pattern to a target along a second axis (block 502). Once the light source is activated, the imaging assembly captures a first image of the target along a second axis (block 504). The imaging system deactivates the light source (block 506) and captures a second image of the target along the second axis (block 508). Then, a ranging failure may occur (block 510). A ranging failure may occur for a variety of reasons, including improper placement of the aiming light pattern, or placement of the aiming light pattern on a reflective surface. If a ranging failure occurs, a focusing sequence is executed with a focus ramp profile based on the user selectable profile (block 512). The focus module may set a focus characteristic of an imaging assembly based on an image processor executing the focusing sequence in response to a ranging failure (block 514).

It should be noted that the methods described above describe possible implementations, and that the operations and the steps may be rearranged or otherwise modified and that other implementations are possible. Furthermore, aspects from two or more of the methods may be combined.

In an example, the user selectable profile is a far range priority mode. In the far range priority mode, the focus ramp profile includes a first ranging sequence that progressively focuses on a plurality of predetermined decreasing distances. Thus, when a ranging failure occurs, the focus ramp profile that is executed starts with larger distances, decreasing the distance overtime. In one example, two cameras, a first camera and a second, are used to progressively focus on the plurality of predetermined decreasing distances, wherein the first camera is configured to focus on a first portion of the plurality of predetermined decreasing distances and the second camera is configured to focus on a second portion of the plurality of predetermined decreasing distances.

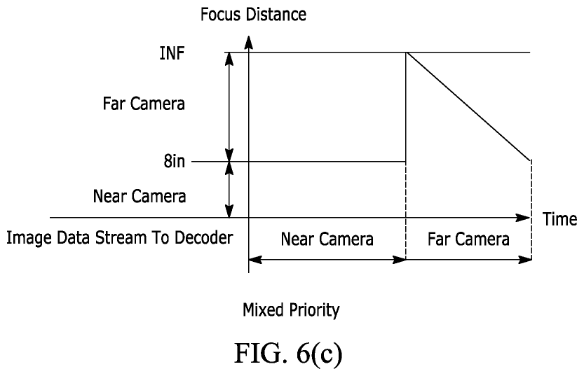

FIG. 6A is an example embodiment of a far range priority focusing sequence in accordance with the present disclosure. As illustrated in FIG. 6A, the x-axis represents time while the y-axis represents the focus distance. At time zero, a first camera, or far camera, is configured to focus on a first portion of the plurality of predetermined decreasing distances. When the first camera focuses on, for example, a focus distance of 8 inches, a transition to the second camera, or near camera, occurs. The second camera is then configured to focus on a second portion of the plurality of predetermined decreasing distances. Further, the portion below the x-axis represents the data flow from each imaging assembly.

In another example, the user selectable profile is a near range priority mode. In the near range priority mode, the focus ramp profile includes a second ranging sequence that progressively focuses on a plurality of predetermined increasing distances. Thus, when a ranging failure occurs, the focus ramp profile that is executed starts with shorter distances, increasing the distance overtime. In one example, two cameras, a first camera and a second camera, are used to progressively focus on the plurality of predetermined increasing distances, wherein the first camera is configured to focus on a first portion of the plurality of predetermined increasing distances and the second camera is configured to focus on a second portion of the plurality of predetermined increasing distances.

The first camera may be a near-focused camera with the short wide imaging FOV 222 for increased performance at the shorter distances. The second camera may be a near-focused camera with the wide imaging FOV 231 for increased performance at greater distances. Thus, when the user selectable profile is in near range priority mode, the first camera is given priority over the second camera in the focus ramp profile.

FIG. 6B is an example embodiment of a near range priority focusing sequence in accordance with the present disclosure. As illustrated in FIG. 6B, the x-axis represents time while the y-axis represents the focus distance. At time zero, a first camera, or near camera, is configured to focus on a first portion of the plurality of predetermined increasing distances. When the first camera focuses on, for example, a focus distance of 8 inches, a transition to the second camera, or far camera, occurs. The second camera is then configured to focus on a second portion of the plurality of predetermined increasing distances. Further, the portion below the x-axis represents the data flow from each imaging assembly.

In another example, the user selectable profile is a mixed range priority mode. In the mixed range priority mode, the focus ramp profile includes either a first ranging sequence or a second ranging sequence. The first ranging sequence progressively focuses on a plurality of predetermined decreasing distances, and the second ranging sequence progressively focuses on a plurality of predetermined increasing distances. The image processor determines whether the focus ramp profile executes the first ranging sequence or the second ranging sequence based on a previous decode event.

For example, a user may be located in a warehouse and operate an imaging system to scan a target at far distances. While using the imaging system, a user may successfully scan a first target at a far distance, which is known as a decode event. However, when the user attempts to scan a second target, a ranging failure may occur. In the mixed range priority mode, the image processor uses the previous, successful decode event to determine that the first target was at far distance. And based on this determination, the image processor would execute the first ranging sequence that focuses on a plurality of predetermined decreasing distances. This may be advantageous because, if the first ranging sequence begins focusing at far distances, the focus distance may be more quickly determined as the user previously scanned a target at a far distance.

FIG. 6C is an example embodiment of a mixed range priority focusing sequence in accordance with the present disclosure. As illustrated in FIG. 6C, the x-axis represents time while the y-axis represents the focus distance. At time zero, a first camera, or near camera, is configured to focus on a first portion of the plurality of predetermined increasing distances. If the image is not decoded, the second camera, or far camera, is configured to focus on a second portion of the plurality of predetermined decreasing distances. Further, the portion below the x-axis represents the data flow from each imaging assembly.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An imaging system for use in a variable focus indicia reader, comprising:
a light source configured to direct an aiming light pattern to a target, the light source directed along a first axis;
a controller configured to activate and deactivate the light source;
an imaging assembly configured to capture imaging data of an environment appearing within a field of view of the imaging assembly, wherein imaging data comprises a first image of the target along a second axis and a second image of the target along the second axis, wherein the light source is deactivated during capture of the first image and the light source is activated during capture of the second image;
an image processor configured to execute a focusing sequence in response to a ranging failure, wherein the focusing sequence comprises a focus ramp profile determined from a user selectable profile; and
a focus module configured to set a focus characteristic of the imaging assembly based on the image processor executing the focusing sequence in response to the ranging failure.

2. The imaging system of claim 1, wherein the focus ramp profile comprises a first ranging sequence when the user selectable profile is a far range priority mode, wherein the first ranging sequence progressively focuses on a plurality of predetermined decreasing distances.

3. The imaging system of claim 2, wherein the first ranging sequence uses a first camera and a second camera to progressively focus on the plurality of predetermined decreasing distances, wherein the first camera is configured to focus on a first portion of the plurality of predetermined decreasing distances and the second camera is configured to focus on a second portion of the plurality of predetermined decreasing distances.

4. The imaging system of claim 3, wherein each of the plurality of predetermined increasing distances in the first portion is greater than each of the plurality of predetermined increasing distances in the second portion.

5. The imaging system of claim 1, wherein the focus ramp profile comprises a second ranging sequence when the user selectable profile is a near range priority mode, wherein the second ranging sequence progressively focuses on a plurality of predetermined increasing distances.

6. The imaging system of claim 5, wherein the second ranging sequence uses a first camera and a second camera to progressively focus on the plurality of predetermined increasing distances, wherein the first camera is configured to focus on a first portion of the plurality of predetermined increasing distances and the second camera is configured to focus on a second portion of the plurality of predetermined increasing distances.

7. The imaging system of claim 6, wherein each of the plurality of predetermined increasing distances in the first portion is less than each of the plurality of predetermined increasing distances in the second portion.

8. The imaging system of claim 1, wherein the focus ramp profile comprises a first ranging sequence or a second ranging sequence when the user selectable profile is a mixed range priority mode, wherein the first ranging sequence progressively focuses on a plurality of predetermined decreasing distances, and the second ranging sequence progressively focuses on a plurality of predetermined increasing distances.

9. The imaging system of claim 8, wherein the image processor determines whether the focus ramp profile comprises the first ranging sequence or the second ranging sequence based on a previous decode event.

10. A method of determining a distance to a target to be read by an imaging system, comprising:
activating a light source configured to direct an aiming light pattern to a target, the light source directed along a first axis;
capturing a first image of the target along a second axis;
deactivating the light source;
capturing a second image of the target along the second axis; and
setting a focus characteristic of an imaging assembly based on an image processor executing a focusing sequence in response to a ranging failure, wherein the focusing sequence comprises a focus ramp profile determined from a user selectable profile.

11. The method of claim 10, wherein the focus ramp profile comprises a first ranging sequence when the user selectable profile is a far range priority mode, wherein the first ranging sequence progressively focuses on a plurality of predetermined decreasing distances.

12. The method of claim 11, wherein the first ranging sequence uses a first camera and a second camera to progressively focus on the plurality of predetermined decreasing distances, wherein the first camera is configured to focus on a first portion of the plurality of predetermined decreasing distances and the second camera is configured to focus on a second portion of the plurality of predetermined decreasing distances.

13. The method of claim 12, wherein each of the plurality of predetermined increasing distances in the first portion is greater than each of the plurality of predetermined increasing distances in the second portion.

14. The method of claim 10, wherein the focus ramp profile comprises a second ranging sequence when the user selectable profile is a near range priority mode, wherein the second ranging sequence progressively focuses on a plurality of predetermined increasing distances.

15. The method of claim 14, wherein the second ranging sequence uses a first camera and a second camera to progressively focus on the plurality of predetermined increasing distances, wherein the first camera is configured to focus on a first portion of the plurality of predetermined increasing distances and the second camera is configured to focus on a second portion of the plurality of predetermined increasing distances.

16. The method of claim 15, wherein each of the plurality of predetermined increasing distances in the first portion is less than each of the plurality of predetermined increasing distances in the second portion.

17. The method of claim 10, wherein the focus ramp profile comprises a first ranging sequence or a second ranging sequence when the user selectable profile is a mixed range priority mode, wherein the first ranging sequence progressively focuses on a plurality of predetermined decreasing distances, and the second ranging sequence progressively focuses on a plurality of predetermined increasing distances.

18. The method of claim 17, wherein the image processor determines whether the focus ramp profile comprises the first ranging sequence or the second ranging sequence based on a previous decode event.

19. A non-transitory computer readable storage medium storing one or more computer programs adapted to cause a processor based system to execute steps comprising:
activating a light source configured to direct an aiming light pattern to a target, the light source directed along a first axis;
capturing a first image of the target along a second axis;
deactivating the light source;
capturing a second image of the target along the second axis; and
setting a focus characteristic of an imaging assembly based on an image processor executing a focusing sequence in response to a ranging failure, wherein the focusing sequence comprises a focus ramp profile determined from a user selectable profile.

20. The non-transitory computer readable storage medium of claim 19, wherein the focus ramp profile comprises a first ranging sequence when the user selectable profile is a far range priority mode, wherein the first ranging sequence progressively focuses on a plurality of predetermined decreasing distances.
